(19) United States
(12) Patent Application Publication
(10) Pub. No.: US 2011/0248952 A1
(43) Pub. Date: Oct. 13, 2011

(54) TOUCH DISPLAY APPARTUS

(75) Inventors: Wen-Chun Wang, Taichung City (TW); Chih-Chang Lai, Taichung County (TW); Lo-Hsien Tsai, Taoyuan County (TW); Kun-Chang Ho, Taichung City (TW)

(73) Assignee: WINTEK CORPORATION, Taichung (TW)

(21) Appl. No.: 12/913,771

(22) Filed: Oct. 28, 2010

(30) Foreign Application Priority Data
Apr. 9, 2010 (TW) 99111115

(51) Int. Cl. G06F 3/045

(52) U.S. Cl. 345/174

(57) ABSTRACT

A touch display apparatus including a display module, a circuit board, and an insulation elastic element is provided. The display module has a display surface, and the display module includes a metal frame, wherein at least of a portion of the metal frame is opposite to the display surface. The circuit board is disposed at a side of the display module away from the display surface. The circuit board has a plurality of capacitance sensing element disposed corresponding to a plurality of corners of the display module. The insulation elastic element is disposed between the circuit board and the display module. The capacitance sensing elements are separated from the metal frame at a changeable distance and a sensed capacitance formed between the capacitance sensing elements and the metal frame is changed with the changeable distance.

### CROSS-REFERENCE TO RELATED APPLICATION

This application claims the priority benefit of Taiwan application serial no. 99111115, filed on Apr. 9, 2010. The entirety of the above-mentioned patent application is hereby incorporated by reference herein and made a part of this specification.

### BACKGROUND OF THE INVENTION

1. Field of the Invention

The invention is related to a touch display apparatus, and more particularly, to a touch display apparatus in which a display quality of a display module is not influenced by a touch element.

2. Description of Related Art

Recently, the touch element such as a touch panel or the like is disposed on a display surface of a display panel for accomplishing touch sensing function of the touch display panels. Therefore, the display quality of the display panel may become unsatisfactory due to the disposition of the touch panel or the touch element on the display surface. Furthermore, for having a desirable light transmission characteristic, the touch panel or the touch element is preferably made by transparent materials. Accordingly, the issues such as how to properly assemble a display panel and a touch element, how to improve the manufacture yield, and how to prevent from the abovementioned shortcomings are required to be overcome in the technology of the touch display panel.

### SUMMARY OF THE INVENTION

The invention provides a touch display apparatus in which a touch element is disposed on a backside of a display module so as to prevent from the negative influence on the display quality of the display module.

The invention provides a touch display apparatus including a display module, a circuit board, and an insulation elastic element. The display module has a display surface, and the display module includes a metal frame, wherein at least of a portion of the metal frame is opposite to the display surface. The circuit board is disposed at a side of the display module away from the display surface. The circuit board has a plurality of capacitance sensing elements disposed corresponding to a plurality of corners of the display module. The insulation elastic element is disposed between the circuit board and the display module. The capacitance sensing elements are separated from the metal frame at a changeable distance and a sensed capacitance between the capacitance sensing elements and the metal frame is changed with the changeable distance.

In view of the above, an insulation elastic element is disposed between the capacitive sensing elements and the metal frame of the display module in the invention so that a sensed capacitance sensed by the capacitance sensing elements is changed with a distance between the capacitance sensing elements and the metal frame. Accordingly, no touch element is disposed on the display surface of the display module in the touch display apparatus so as to have the touch sensing function without having a negative influence on the display quality.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic top view of a touch display apparatus according to an embodiment of the invention.

FIG. 2 illustrates a schematic cross-sectional view of a touch display apparatus according to an embodiment of the invention.

FIG. 3 illustrates a schematic cross-sectional view of a touch display apparatus according to another embodiment of the invention.

FIG. 4 schematically illustrates a touch sensing method of a touch display apparatus according to an embodiment of the invention.

FIG. 5 illustrates a schematic top view of a touch display apparatus according to further another embodiment of the invention.

### DESCRIPTION OF EMBODIMENTS

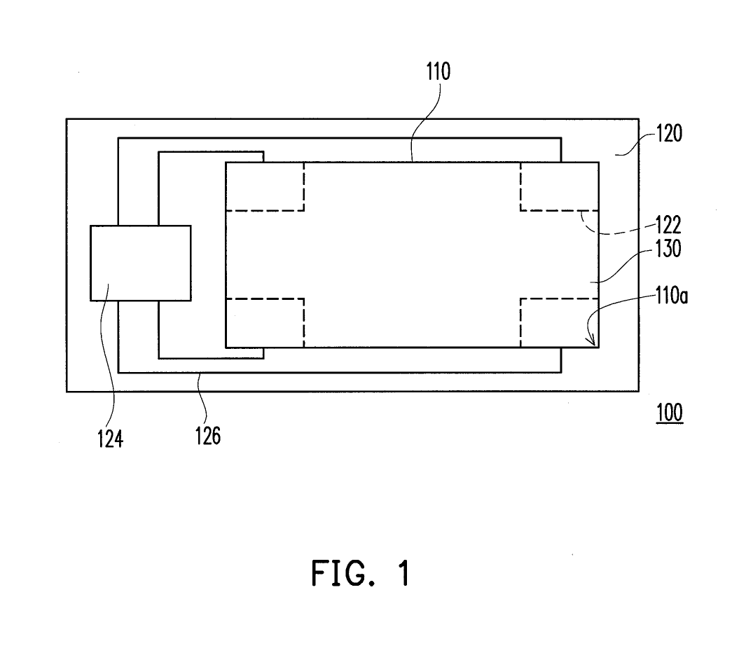

FIG. 1 is a schematic top view of a touch display apparatus according to an embodiment of the invention. Referring to FIG. 1, a touch display apparatus 100 includes a display module 110 and a circuit board 120. The display module 110 is, for example, consisted of a flat display panel. For example, the display module 110 can be a liquid crystal display module, an electronic paper display module, an organic light emitting display module, a plasma display module, or the like. A plurality of capacitance sensing elements 122 and a touch sensing chip 124 are disposed on the circuit board 120. The touch sensing chip 124 is electrically connected to the capacitance sensing elements 122 through a wiring layer 126 disposed in the circuit board 120, for example. Moreover, the disposition locations of the capacitance sensing elements 122 are corresponding to a plurality of corners 110a of the display module 110.

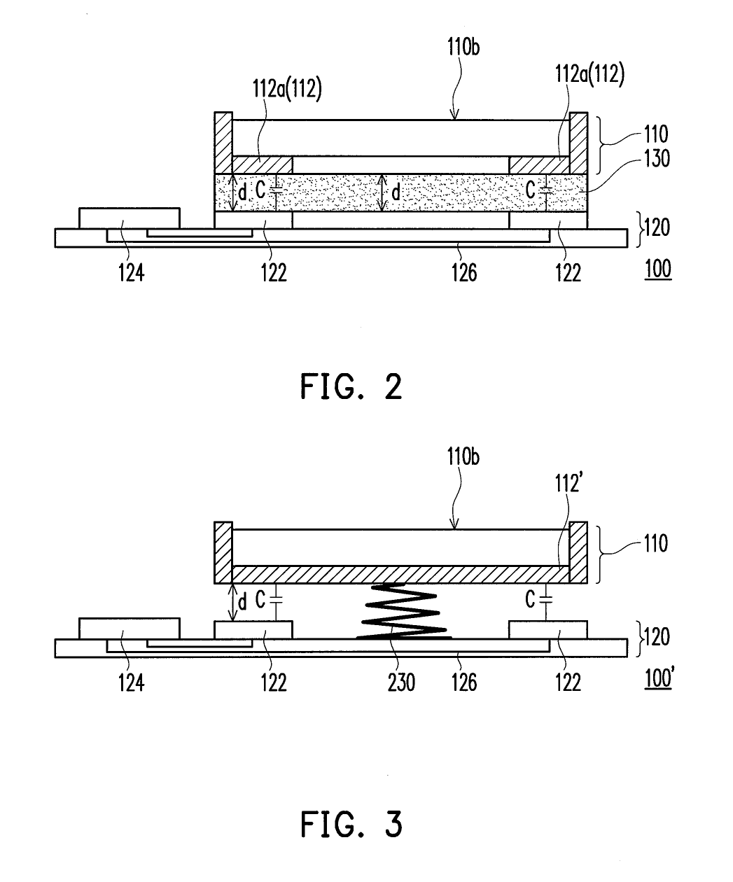

FIG. 2 illustrates a schematic cross-sectional view of a touch display apparatus according to an embodiment of the invention. Referring to FIG. 1 and FIG. 2, in addition to the elements such as the display module 110, the circuit board 120, etc. illustrated in FIG. 1, the touch display apparatus 100 further includes an elastic insulation layer 130 in the present embodiment. In addition, the display module 110 has a metal frame 112, for example. The elastic insulation layer 130 is disposed between the capacitance sensing element 122 and the metal frame 112. Accordingly, the capacitance sensing elements 122 are separated from the metal frame 112 at a changeable distance d. When the display module 110 is not touched, the changeable distance d can be 1.5 mm in the present embodiment. Therefore, the thickness of the touch display apparatus 100 is merely slightly increased due to the disposition of the elastic insulation layer 130 so that the requirement of thin volume is still satisfied.

It is noted that the metal frame 112 of the present embodiment is connected to a grounding voltage or a fixed voltage. In addition, the metal frame 112 can be consisted of a plurality of frame portions 112a and each of the frame portions 112a is faced to one of the capacitance sensing elements 122. Accordingly, a sensed capacitance C can be formed between each of the capacitance sensing elements 122 and one frame portion 112a of the metal frame 112. Generally, the value of a capacitance is inversely proportional to the distance between the two objects forming the capacitance and positively proportional to the overlapped area of the two objects. When the overlapped area of the capacitance sensing element 122 and the metal frame 112 is fixed, the sensed capacitance C sensed by each of the capacitance sensing elements 122 can be related to the change of the changeable distance d. The principle is used in the present embodiment for facilitating the touch sensing function. Namely, any touch sensing element is not required to be disposed on the display surface 110b according to the present embodiment and any large area sensing electrode is not required for accomplishing the touch sensing function. Therefore, the display quality of the display module 110 is not influenced by other elements, which is conducive to improve the display quality of the whole product. Furthermore, the manufacture method of the touch display apparatus 100 is much simple.

In addition, for keeping the existence of the sensed capacitance C, the changeable distance d is substantially larger than 0. That is to say, the capacitance sensing elements 122 are not contacted with the metal frame 112 so that a capacitance couple effect between the capacitance sensing elements 112 and the metal frame 122 is maintained.

In addition to the disposition of the elastic insulation layer 130 between the capacitance sensing elements 122 and the metal frame 112, the elastic elements such as a spring illustrated in FIG. 3, a gasket, or a silicon can be disposed between the capacitance sensing element 122 and the metal frame 112 for providing a supporting function in other embodiments. FIG. 3 illustrates a schematic cross-sectional view of a touch display apparatus according to another embodiment of the invention. Referring to FIG. 3, the touch display apparatus 100′ is substantially similar to the touch display apparatus 100 depicted in FIG. 2 and the difference lies in the type of the elastic element. That is to say, the spring 230 used in the touch display apparatus 100′ is served as the separation element disposed between the capacitance sensing elements 122 and the metal frame 112′ so that the changeable distance d can be changed with an external force. In addition, the metal frame 112′ has a complete and continuous supporting surface in the present embodiment rather than has a plurality of frame portions, wherein the supporting surface is opposite to the display surface 110b. It is noted that a material of the spring 230 providing the supporting function is an insulation material in the present embodiment so that the spring 230 does not have influence on the capacitance couple effect between the capacitance sensing elements 122 and the metal frame 112′.

Specifically, the spring 230 and the elastic insulation layer 130 are merely taken as examples but not used for limiting the invention. In other embodiments, the insulation elastic element for supporting between the display module 110 and the circuit board 120 can be an elastic gasket, a silicon material, or the like having proper elasticity. Only an insulating and elastic element is disposed between the display module 110 and the circuit board 120 can the display function and the touch sensing function be simultaneously accomplished in the invention.

As shown in FIG. 2 and FIG. 3, the dispositions of the elastic insulation layer 130 and the spring 230 facilitate the changeable distance d between each of the capacitance sensing elements 122 and the metal frame 112 or 112′ to change with a touch action of the user. In addition, the variance of the changeable distance d is different when the touch position of the user is changed. For example, larger stress may be applied at the region closer to the touch position so that the reduction of the changeable distance d is distinct. On the contrary, smaller stress may be applied at the region farther from the touch position so that the reduction of the changeable distance d is vague.

The value of the sensed capacitance C is substantially inversely proportionally to the changeable distance d between the capacitance sensing elements 122 and the metal frame 112 or 112′. Therefore, the variations of the sensed capacitances C are related to the change of the changeable distance d. Namely, the variation of the sensed capacitance C can be used as a reference for the display module 110 to define the touch position. Specifically, the capacitance sensing elements 122 corresponding to the corners 110a may be sequentially scanned. Particularly, when one of the capacitance sensing elements 122 is scanned, the others of the capacitance sensing elements 122 are, for example, connected to the grounding voltage. Therefore, the capacitances of the capacitance sensing elements 122 are avoided from interference with each other.

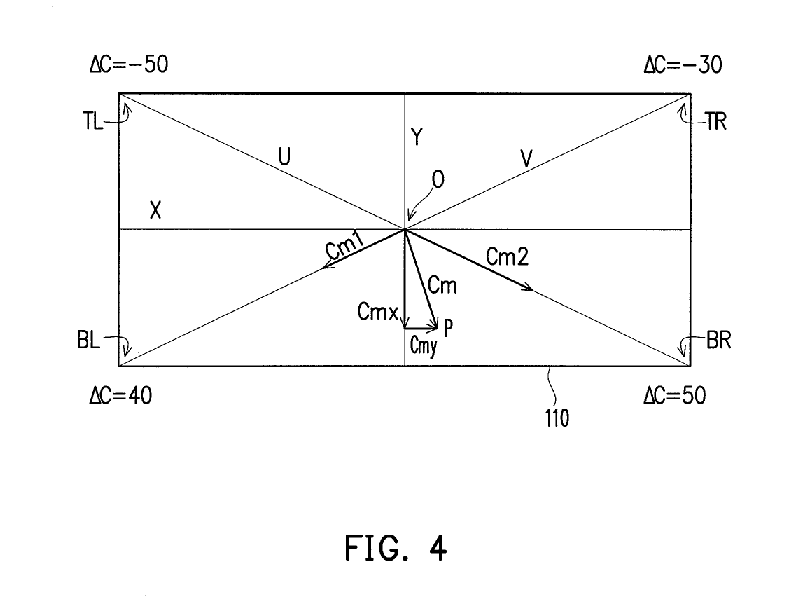

FIG. 4 schematically illustrates a touch sensing method of a touch display apparatus according to an embodiment of the invention. Referring to FIG. 1, FIG. 2, and FIG. 4 together, for clearly showing the corners 110a at different positions, the corners 110a are respectively defined as a left top corner TL, a right top corner TR, a left bottom corner BL, and a right bottom corner BR in FIG. 4. Herein, a straight line from the left top corner TL to the right bottom corner BR is, for example, defined as a U axis and a straight line from the right top corner TR to the left bottom corner BL is, for example, defined as a V axis. In addition, an X axis and a Y axis respectively represent the long-axis direction and the short-axis direction of the display module 110, and the origin point O is the center of the display module 110.

When the display module 110 is not touched by the user, a center of gravity of the display panel 110 is located at the origin point O. At the meantime, the sensed capacitances C sensed by all capacitance sensing elements 122 can respectively be an initial value. When the user touches the display module 110, the changeable distances d are redistributed to be different from the initial state. Therefore, all the capacitance sensing elements 122 can sense another sensed capacitances C which are respectively a sensed value. If the variations between the sensed values and the corresponding initial values are obtained, the distribution of the changeable distances d can be adjusted so as to determine the coordinate of the touch position P. In other words, the present embodiment is conducive to provide a simple touch sensing method.

In the present embodiment, the variation between the sensed value and the initial value can be normalized according to the predetermined touch sensing resolution of the display module 110 to obtain a reference capacitance value ΔC. It is assumed that the X axis is predetermined to be divided in to 320 units with consistent pitch and the Y axis is predetermined to be divided in to 240 units with consistent pitch in the display module 110. Therefore, the distance from the origin point O to each of the corners (the left top corner TL, the right top corner TR, the left bottom corner BL, and the right bottom corner BR) in the U axis or the V axis should be divided into 200 units, i.e. the resolution from the origin point O to each of the corners in the U axis or the V axis should be 200. For complying with the resolution, a greatest variation and a smallest variation between the sensed value and the initial value sensed by each of the capacitance sensing elements 122 under a touched condition are measured after the touch display apparatus 100 is assembled, and then the greatest variation is normalized into +100 and the smallest variation is normalized into −100 so as to define the relationship between the sensed variation and the reference capacitance ΔC.

As shown in FIG. 4, when a touch action of the user is performed on the position P, the reference capacitance ΔC sensed by the capacitance sensing element 122 at the left top corner TL is normalized into −50, the reference capacitance ΔC sensed by the capacitance sensing element 122 at the right top corner TR is normalized into −30, the reference capacitance ΔC sensed by the capacitance sensing element 122 at the left bottom corner BL is normalized into +40, and the reference capacitance ΔC sensed by the capacitance sensing element 122 at the right bottom corner BR is normalized into +50. According to the above values, the distribution of the reference capacitances ΔC may be represented as a vector Cm2 with a value of 100 from the origin point O to the right bottom corner BR on the U axis. In addition, the distribution of the reference capacitances ΔC may be represented as a vector Cm1 with a value of 70 from the origin point O to the left bottom corner BL on the V axis. The resultant vector Cm of the vector Cm1 and the vector Cm2 can be related to the touch position P.

For example, a component Cmx on the X axis and a component Cmy on the Y axis of the resultant vector Cm represent the spatial relationship of the touch position P to the origin point O. In the present embodiment, the values of the component Cmx and the component Cmy are respectively 24 and 102. If the coordinate of the origin point O corresponding to the left top corner TL is (160, 120), the touch position P corresponding to the left top corner TL can be (160+24, 120+102), i.e. (184, 222).

That is to say, the reference capacitances ΔC sensed by the capacitance sensing elements 122 at different corners are changed with different touch positions P so that the resultant vector Cm calculated from the reference capacitances ΔC can be related to the touch position P. In addition, in other embodiments for calculating the touch position P, the variation between the sensed value and the initial value can be first calculated. Then, a distribution of the variations is obtained and the distribution is normalized according to the predetermined resolution, which is served as the reference of the touch position P. That is to say, the variations are not necessarily to be normalized prior to the analysis of the distribution of the variations.

Furthermore, the top view of the touch display apparatus 100′ can be referred to the top view of the touch display apparatus 100 depicted in FIG. 1. As shown in FIG. 1, the design of the embodiments is accomplished by rendering the amount of the capacitance sensing elements 122 equal to the amount of the corners 110a of the display module 110. Nevertheless, it is also complied with the spirit of the invention that the amount of the capacitance sensing elements 122 is a positive integral multiple of the amount of the corners 110a of the display module 110.

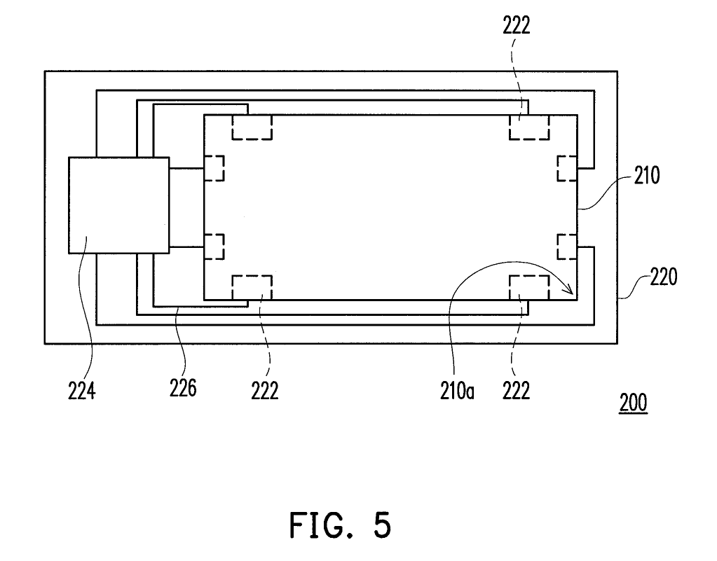

For example, FIG. 5 illustrates a schematic top view of a touch display apparatus according to further another embodiment of the invention. Referring to FIG. 5, a touch display apparatus 200 includes a display module 210 and a circuit board 220. The display module 210 is, for example, consisted of a flat display panel. For example, the display module 210 can be a liquid crystal display module, an electronic paper display module, an organic light emitting display module, a plasma display module, or the like. A plurality of capacitance sensing elements 222 and a touch sensing chip 224 are disposed on the circuit board 220. The touch sensing chip 224 is electrically connected to the capacitance sensing elements 222 through a wiring layer 226 disposed in the circuit board 220, for example. Moreover, the disposition locations of the capacitance sensing elements 222 are corresponding to a plurality of corners 210a of the display module 210.

It is noted that the amount of the capacitance sensing elements 222 is two times of the amount of the corners 210a and two capacitance sensing elements 222 are disposed corresponding to one corner 210a. That is to say, the amount of the corners 210a can be equal to or different from the amount of the capacitance sensing element 222. During performing the touch sensing function, the signal sensed by a plurality of capacitance sensing elements 222 corresponding to the same corner 210a can be simultaneously used as the reference for determining the touch position. In one embodiment, an average of the sensed capacitances sensed by the plurality of capacitance sensing elements 222 corresponding to the same corner 210a can be represented as the touch signal of the corner 210a. Certainly, in other embodiments, the sensed capacitances sensed by the plurality of capacitance sensing elements 222 corresponding to the same corner 210a can be directly summed up or added in certain proportions to be served as the reference of the touch position.

In summary, the touch element is disposed at a side of the display module away from the display surface in the invention. Therefore, the display effect of the display module is not influenced by the disposition of the touch element. Namely, the touch display apparatus of the invention has desirable display quality. In addition, only a plurality of capacitance sensing elements are disposed for providing the touch sensing function in the invention so as to simplify the structure and the element design of the touch display apparatus.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display apparatus, comprising:
a display module having a display surface, and the display module comprising a metal frame, wherein at least of a portion of the metal frame is opposite to the display surface;
a circuit board disposed at a side of the display module away from the display surface, the circuit board having a plurality of capacitance sensing elements corresponding to a plurality of corners of the display module; and
an insulation elastic element disposed between the circuit board and the display module, the capacitance sensing elements separated from the metal frame at a changeable distance, wherein a sensed capacitance formed between the capacitance sensing elements and the metal frame is changed with the changeable distance.

2. The touch display apparatus as claimed in claim 1, wherein the changeable distance is greater than 0.

3. The touch display apparatus as claimed in claim 1, wherein the insulation elastic element is a spring, a silicon, or a gasket.

4. The touch display apparatus as claimed in claim 1, wherein the insulation elastic element is an elastic insulation layer.

5. The touch display apparatus as claimed in claim 1, wherein an amount of the capacitance sensing elements is equal to a positive integral multiple of an amount of the corners of the display module.

6. The touch display apparatus as claimed in claim 1, wherein an amount of the capacitance sensing elements is two times of an amount of the corners of the display module, and two of the capacitance sensing elements are disposed corresponding to one of the corners.

7. The touch display apparatus as claimed in claim 1, further comprising a touch sensing chip disposed on the circuit board, and the touch sensing chip being electrically connected to the capacitance sensing elements.

8. The touch display apparatus as claimed in claim 1, wherein the metal frame is connected to a fixed voltage or a grounding voltage.

9. The touch display apparatus as claimed in claim 1, wherein the metal frame comprises a plurality of frame portion, and each of the frame portions is faced to one of the capacitance sensing elements.

10. The touch display apparatus as claimed in claim 1, wherein the metal frame has a complete and continuous supporting surface and the supporting surface is opposite to the display surface.
